(19) United States
(12) Patent Application Publication
(10) Pub. No.: US 2006/0278299 A1
(43) Pub. Date: Dec. 14, 2006

(54) Method of charging low temperature liquified gas

(75) Inventors: Hyang Ja Jang, Nam-Gu (KR); Yuichi Iikubo, West Lafayette, IN (US); Dae Hyun Kim, Nam-Gu (KR); Cheol Ho Kim, Nam-Gu (KR)

Correspondence Address: John S. Egbert;Egbert Law Offices, 7th Floor, 412 Main Street, Houston, TX, 77002, US

(73) Assignee: ULSAN CHEMICAL Co., Ltd., Nam-ku (KR)

(21) Appl. No.: 11/404,595

(22) Filed: Apr. 17, 2006

(30) Foreign Application Priority Data
Jun. 14, 2005 (KR) 10-2005-0050670

(51) Int. Cl. F17C 13/00; B65B 1/04

(52) U.S. Cl. 141/2; 62/50.6

(57) ABSTRACT

Disclosed is a method of charging a low temperature liquefied gas in a high pressure charging cylinder using a diaphragm pump. The method is advantageous in that it is possible to charge a low temperature liquefied gas which is to be made highly pure in a high pressure gas cylinder using a simple process in which the liquefied gas does not deteriorate and small energy is consumed.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to a method of charging a low temperature liquefied gas, which is present in a gaseous phase at normal temperature, at a high pressure in a high pressure gas cylinder. More particularly, the present invention pertains to a method of charging a low temperature liquefied gas In a high pressure gas cylinder using a diaphragm pump.

### BACKGROUND OF THE INVENTION

Generally, liquefied gas having a low boiling point is present in a liquid state at a critical low temperature or less, but is present in a gaseous state above the critical temperature. In the present invention, this gas is called a low temperature liquefied gas. Due to the above characteristics, the liquefied gas is charged in a gaseous state at a pressure of several tens −200 kg/cm²G in a high pressure cylinder. The liquefied gas is exemplified by nitrogen, oxygen, and argon, which are extensively used for general purposes, and nitrogen trifluoride (NF₃, boiling point: −129° C.), sulfur hexafluoride (SF₆), anhydrous hydrochloric acid (AHCl), anhydrous hydrogen bromide (AHBr), carbon tetrafluoride (CF₄), and ethane hexafluoride (C₂F₆) , which are used in the semiconductor industry.

A conventional method of charging liquefied gas comprises condensing it at low temperatures during production, storing it in a liquid state in a storage container, passing it through a vaporizer or a heat exchanger to vaporize it, and charging the vaporized gas in a high pressure gas cylinder while it is compressed using a compressor.

The reason why the method, in which the liquefied gas is vaporized and the vaporized gas is charged in the cylinder while it is compressed using the compressor, is frequently adopted when the low temperature liquefied gas is charged in the cylinder as described above is as follows. A pump or the compressor is mainly used at normal temperature, and, if the pump is applied to a liquid having a low boiling point, cavitation (a phenomenon in which desirable operation of a pump becomes impossible when a liquid having a low boiling point is vaporized and then charged in a pump head) occurs, making normal operation of the pump impossible. However, in the case of the compressor for compressing the vaporized gas, it is not necessary to worry about the above-mentioned phenomenon.

However, the method is problematic in that a temperature of the charged gas rises due to heat of compression generated when the gas is compressed using the compressor, and, in serious cases with respect to this, a product is decomposed, and thus, impurities are increased to reduce purity. Other problems are that maintenance cost is high due to the abrasion of parts and a charging speed is reduced at a high pressure. However, there is no clear solution plan due to characteristics of the compressor, but complementary measures, such as minimization of problems caused by heat of compression using cooling of a compressor head or discharged gas and the removal of impure particles using a filter mounted on a discharge part, are conducted. Nevertheless, essential problems have not been avoided.

Moreover, in accordance with advances in the semiconductor industry, demand for gas of higher purity used in the same field is growing, and the criterion for impurity content of the gas is becoming increasingly strict.

In the conventional method in which the liquefied gas is vaporized and the vaporized gas is charged in the container while it is compressed using the compressor, energy consumption is high during the vaporization and compressing processes, and, in the case of gas which is to be made highly pure, such as nitrogen trifluoride (NF₃) gas used as an etching gas in a process of fabricating semiconductors, there is the undesirable high possibility of deterioration of the gas.

Accordingly, in the above field, there remains a need to develop a method of charging a liquefied gas, in which energy consumption is reduced and deterioration of the gas is avoided during a charging process.

### BRIEF SUMMARY OF THE INVENTION

The present invention relates to a method in which a low temperature liquefied gas is compressed in a liquid state using a diaphragm pump and the compressed liquid is directly charged in a high pressure gas cylinder or charged in the cylinder after passing through a vaporizer.

The present inventors have found that, unlike a conventional method in which gas is charged in a gaseous state in a high pressure gas cylinder using a compressor, when liquefied gas, such as NF₃, which is to be made highly pure, is charged in a high pressure gas cylinder using a diaphragm pump, deterioration does not occur during the charging process and the charging is achieved using little energy, thereby accomplishing the present invention.

An object of the present invention is to provide a novel charging technology in which a low temperature liquefied gas is charged using a diaphragm pump, particularly a diaphragm pump having a remote head, thus problems of heat generation caused during a compression process using a compressor, of high energy cost, and of vibration and noise are originally prevented. The technology is economical and stable and therefore useful for general purposes and for the charging of ultra-highly pure semiconductor gas, such as NF₃.

### BRIEF DESCRIPTION OF THE SEVERAL VIEWS OF THE DRAWINGS

The above and other objects, features and advantages of the present invention will be more clearly understood from the following detailed description taken in conjunction with the accompanying drawing.

FIG. 1 is a schematic view illustrating a charging process according to the present invention.

### DETAILED DESCRIPTION OF THE INVENTION

As to a pump for pressurizing liquid to transport it, a pump which draws or discharges the liquid using movement of a diaphragm is called a diaphragm pump. A representative example is a fuel pump of a gasoline car. In a method of charging liquefied gas using the diaphragm pump, the liquefied gas can be easily compressed to a desired pressure not in a gaseous state but in a liquid state using the pump during a compression process, and it is possible to conduct transportation at an almost constant flow rate at low and high pressures, thus a charging time can be reduced. Additionally, since heat generation is very small at a high compression ratio, it is possible to safely charge a material, such as NF₃, which has significantly increased reactivity and is significantly decomposed at high temperatures. Furthermore, since liquid (low temperature liquefied gas) is charged in a head part of the pump, lubrication is assured, thus the formation of metal particles by friction or abrasion is originally prevented. Additionally, in comparison with a process of compressing gas using a high capacity compressor, since a small-sized and low capacity device can be used, it is possible to minimize power, operation, and maintenance costs, and desirable operation efficiency is assured because the charging time is shortened.

The diaphragm pump is used to transport and charge liquid, and typically comprises a head including a diaphragm and a check valve, a motor which provides power, and a mechanical operation part (a gear and an operating part of a piston) which generates fluid pressure using rotational strength of the motor. However, the physical properties of oil significantly change at low and high temperatures. Particularly, since oil freezes or its viscosity drastically changes at low temperatures, it is difficult to conduct normal operation, and consequently there is a limit in that it cannot be used in a low temperature process. In the present invention, in order to avoid the above-mentioned limit of the diaphragm pump, the diaphragm pump, which is designed to include a pump head of an oil side and a remote head of a fluid side so that oil of the diaphragm and the low temperature liquefied gas do not come into direct contact with each other, is provided. A fluid which has a low freezing point and minimally changed physical properties at low temperatures is injected into a pipe between both heads to be used as a fluid pressure transferring medium, so that the fluid pressure generated by the pump head is transferred to a fluid to be transported. Thereby, the low temperature liquefied gas is compressed to a high pressure using the diaphragm pump, and then charged in the container.

Any material may be used as the fluid pressure transferring medium for transferring the fluid pressure between the two heads as long as the material is present in a liquid state at normal temperature, has a freezing point of −10 to −150° C., and changes minimally in terms of physical properties at low temperatures. Such a material is exemplified by ethanol, acetone, trichloroethane, dichlorofluoroethane, isopentane, and an antifreezing solution for cars (a mixture of water and ethylene glycol). The above-exemplified fluid is selected to be appropriate to the operation temperature.

In the present invention, it is preferable that a pipe be connected from a storage container, in which the low temperature liquefied gas is stored in a liquid state, to a suction part of the pump, and that a suction pipe be completely insulated or cooled using a low temperature refrigerant so as to prevent cavitation caused by vaporization of a low temperature liquid.

It is preferable that the remote head part of the pump be completely insulated to prevent cavitation and, if necessary, a coil or adouble jacket capable of being cooled using a low temperature refrigerant be provided thereon. A pipe which is connected to a storage tank is connected to a discharge pipe of the pump so that pump primer and any residual solution in the discharge pipe are recycled into the storage tank. During a pump priming process, the liquid circulates from the storage tank through the above pipe, and, after the charging is finished, the residual solution and the pressure in the discharge pipe are recycled into the storage tank therethrough to minimize the loss of products. Furthermore, a manometer is provided to check operation of the pump and a discharge pressure, and a safety device is provided against overpressure. It must be noted that, if the low temperature liquefied gas is fully charged in the pipe and the pipe is airtightly closed, overpressure may occur due to expansion caused by an increase in temperature, and in serious cases, the pipe may be damaged. The liquefied gas which is compressed by the pump is transported through the pipe, connected to charging devices, to a charging container, and it may be directly charged or may be charged after it is vaporized at normal temperature using a separate vaporizer or heat exchanger provided on the discharge pipe. If it is directly charged in the container, a valve of the container is closed after the charging is finished and the container is left at normal temperature to vaporize the charged liquid. A charging amount is measured using a balance, and a manometer is provided on a charging device to check the charging pressure so as to prevent excessive charging. The charging method of the present invention can be applied both to a single charging device and to a plurality of charging devices.

A better understanding of the present invention may be obtained through the following example which is set forth to illustrate, but is not to be construed as the limit of the present invention.

### EXAMPLE

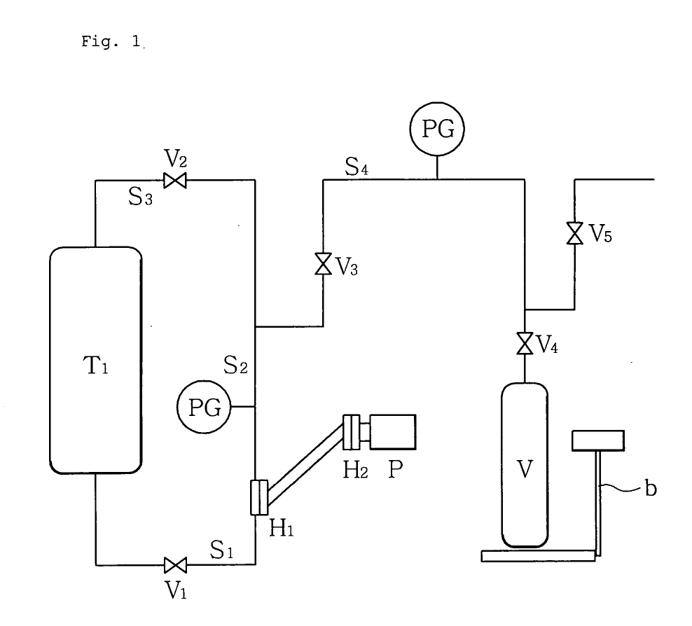

A detailed description will be given of a charging method according to the present invention, referring to FIG. 1. Highly pure NF₃ liquid which was condensed at low temperatures was used as a liquefied gas for a charging test. A storage tank (T₁) was connected to a process for producing NF₃ through a pipe, and a double vacuum jacket was provided on an external surface of the storage tank (T₁) to insulate it. NF₃ collected in the storage tank was transported through a suction pipe (S₁) into a suction part of a diaphragm pump, and the suction pipe (S₁) was made of a double pipe type of vacuum insulating pipe. A coil was attached to a remote head (H₂) of the pump and a low temperature fluid (liquid nitrogen, liquid air or the like) was passed therethrough to maintain the temperature of the remote head at −90° C. Oil for the diaphragm pump was charged in the pump head and an oil storage bath, and dehydrated pump head and air-removed ethanol was charged between the (H₁) and the remote head (H₂) . A manometer was provided at a discharge part of the pump to check normal operation of the pump, and a circulation pipe (S₃) was connected to the storage tank so that the remaining solution in the pipe was recirculated into the storage tank after pump priming and charging were finished. The charging container was connected to a discharge pipe (S₂) of the pump and the charging container was provided on a balance to check a charging amount. The charging was conducted through the following procedure.

1) A charging pipe (S₄) and a high pressure cylinder (G) were connected to each other, and valves (V₁, V₂) were closed and valves (V₃, V₄, V₅) were opened to create a vacuum of 1 Torr or less so as to remove air and moisture from the pipe. Before this, moisture was removed fromt he high pressure cylinder (G) and the high pressure cylinder (G) was vacuumized to prepare charging.

2) After the procedure of 1) was finished, the valves (V₃, V₄, V₅) were closed and the valves (V₁, V₂) were opened to conduct pump priming, and the pump was then operated to conduct circulation.

3) When the temperature of a remote head of a pump was low enough to transport liquid well and pressure was rapidly increased if the valve (V2) was closed, the valves (V₃, V₄) were opened to charge NF₃ liquid in the charging cylinder.

4) After the charging was finished, the valve (V₄) was closed, the pump was stopped, and the valves (V₁, V₂,V₃) were opened to recycle the remaining solution from a charging pipe (S₄) into the storage tank and make pressure uniform therein. All of the valves were closed and the charging cylinder was separated. The charging cylinder was left at normal temperature to increase the temperature to normal temperature.

The method of the present invention is advantageous in that it is possible to charge a low temperature liquefied gas which is to be highly pure in a high pressure gas cylinder using a simple process in which the liquefied gas does not deteriorate and little energy is consumed.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

We claim:

1. A method comprising the steps of:
charging a low temperature liquefied gas in a high pressure charging cylinder using a diaphragm pump.

2. The method as set forth in claim 1, wherein said low temperature liquefied gas is selected from a group consisting of:
nitrogen trifluoride, nitrogen, oxygen, argon, sulfur hexafluoride, anhydrous hydrochloric acid, anhydrous hydrobromic acid, carbon tetrafluoride, and ethane hexafluoride,; and
wherein said diaphragm pump is comprised of a remote head, a pump head separated from said remote head, and a fluid pressure transferring medium between said remote head and said pump head.

3. The method as set forth in claim 2, wherein said fluid pressure transferring medium is comprised of a liquid present in a liquid state at normal temperature and has a freezing point of −10 to −150° C.

4. The method as set forth in claim 3, wherein the fluid pressure transferring medium is selected from a group consisting of:
ethanol, isopentane, an antifreezing solution for cars, acetone, 1,1,1-trichloroethane, dichlorofluoroethane, and mixtures thereof.

5. The method as set forth in claim 1, wherein the cylinder has a liquid, compressed using the pump, directly charged therein, or charged in a gas phase in the cylinder after the liquid is vaporized by an evaporator or a vaporizer provided on a discharge part of the pump.
